(19) United States
(12) Patent Application Publication
(10) Pub. No.: US 2013/0065588 A1
(43) Pub. Date: Mar. 14, 2013

(54) TRANSMITTING DATA OVER MULTIPLE NETWORKS

(71) Applicants: Christoffer Rödbro, Stockholm (SE); Sören Vang Andersen, Esch-Sur-Alzette (LU)

(72) Inventors: Christoffer Rödbro, Stockholm (SE); Sören Vang Andersen, Esch-Sur-Alzette (LU)

(21) Appl. No.: 13/339,956

(22) Filed: Dec. 29, 2011

(30) Foreign Application Priority Data
Sep. 13, 2011 (GB) 1115810.2

(51) Int. Cl. H04W 36/00; H04W 84/04

(52) U.S. Cl. 455/436

(57) ABSTRACT

The invention relates to a method and apparatus for transmitting data from a source device to a destination device in a communications system, including at the device, executing an application which generates data according to an application layer protocol and supplies the data to a first network interface for transmission in a communications session over a first channel; and the device receiving data at the first network interface for supply to the application. The application determines to effect a handover and opens a second channel for the communication session; the application supplies data to a second network interface for transmission over the second channel and generates a message for transmission over the first or second channel to the destination device, said message including a destination address identifying the second network interface for receiving data over the second channel.

### RELATED APPLICATION

This application claims priority under 35 U.S.C. §119 or 365 to Great Britain Application No. GB 1115810.2, filed Sep. 13, 2011. The entire teachings of the above application are incorporated herein by reference.

### TECHNICAL FIELD

The present invention relates to transmitting data from a wireless device in a wireless communication system, particularly in a communication system which provides at least first and second wireless access technologies for a communication session.

### BACKGROUND

FIG. 1 illustrates schematically a wireless communication system in which a first user terminal 2 and a second user terminal 4 wish to communicate. Herein the first user terminal 2 is referred to as the near end or local terminal, and the second user terminal 4 is referred to as the far end or remote terminal.

The communication system comprises a first communication network 6 according to a first wireless access technology, for example, WiFi. The communication system further comprises a second communication network 8 according to a second wireless access technology, for example, WWAN (such as 3G or 4G).

FIG. 1 shows a communication session established between the first and second user terminals via the WiFi network 6. In a communication session, the application addresses data to a network socket which is a combination of a port number and an IP address.

A wireless device has the capability of establishing a communication session via the alternate communication network (for example, WWAN network 8 in FIG. 1) by having multiple wireless interfaces (two in the case of devices in FIG. 1).

In one type of wireless device, data to be transmitted is generated by an application executed on the device, for example, for social communications such as VoIP (Voice over Internet Protocol) calls, instant messaging (IM) chat or live meetings run over a conference framework.

FIG. 2 illustrates a detailed view of the user device 2 on which is executed one such application in the form of client 216. The user device 2 comprises a central processing unit (“CPU”) 202, to which is connected a display 204 such as a screen and an input device such as a keypad 206. The display 204 may comprise a touch screen for inputting data to the CPU 202. An output audio device 210 (e.g. a speaker) and an input audio device 212 (e.g. a microphone) are connected to the CPU 202. In a typical mobile wireless device the display 204, keypad 206, output audio device 210 and input audio device 212 are integrated into the user device 2. The CPU 202 is connected to multiple network interfaces 224a, 224b for communication with the respective networks 68. The network interfaces are provided by a radio access chip 224, which also executes radio control logic for managing the interfaces. The user device 104 also comprises a memory 226 for storing data and applications.

FIG. 2 also illustrates an operating system (OS) 214 executed on the CPU 202. Running on top of the OS 214 is a software stack 216 for the client 108. The software stack shows a client protocol layer 218, a client engine layer 220 and a client user interface layer (UI) 222. Each layer is responsible for specific functions. Because each layer usually communicates with two other layers, they are regarded as being arranged in a stack as shown in FIG. 2. The operating system 214 manages the hardware resources of the device 104 and handles data being transmitted to and from the network 106 via the network interfaces 224a, 224b. The client protocol layer 218 of the client software communicates with the operating system 214 and manages the connections over the communication system. Processes requiring higher level processing are passed to the client engine layer 220, where applications for generating data are executed. The client engine 220 also communicates with the client user interface layer 222. The client engine 220 may be arranged to control the client user interface layer 222 to present information to the user via a user interface and to receive information from the user via the user interface.

In existing devices, such as shown in FIG. 2, there are two possibilities for managing the connections of the wireless interface. In a situation where an application registers with the operating system without specifying a particular allocation of IP address to network socket the network interface which is selected for transmission of data generated by applications in the software stack 216 is determined by the operating system. This is illustrated by the arrow “network indicator” in FIG. 2. Typically, the operating system has a priority list which would state a preferred network and use an alternate network only when the preferred network was not available. For example, a WiFi network can be preferred over a WWAN network, so that the latter is only used if WiFi is not available. Options are available for a user to change the priority list, for example, to force WWAN to be preferred, but then a WiFi network will only be used when WWAN is not available.

In another situation, an application loaded into the CPU polls the operating system to assess what network interfaces are available, and assigns IP addresses accordingly.

This can be done at set-up of the application and also during runtime. The polling activity is instigated by the application.

### SUMMARY

According to an aspect of the present invention, there is provided a method of transmitting data from a source device to a destination device in a communications system, the method comprising: at the device, executing an application which generates data according to an application layer protocol and supplies the data to a first network interface for transmission in a communications session over a first channel; the device receiving data at the first network interface for supply to the application; the application determining to effect a handover and opening a second channel for the communication session; the application supplying data to a second network interface for transmission over the second channel and generating a message for transmission over the first or second channel to the destination device, said message including a destination address identifying the second network interface for receiving data over the second channel.

Another aspect of the invention provides a device for receiving and transmitting data in a communication system, the device comprising: a processor arranged to execute an application which generates data and supplies the data to a network interface for transmission in a communication session over a first channel; the network interface receiving data from a source device over the first channel; the application arranged to detect in a stream of data received over the first channel a message including a destination address identifying a second channel for the communication session, and supplying data for transmission in the communication session over the second channel.

Another aspect of the invention provides a computer program product comprising a non-transitory computer readable medium storing thereon computer readable instructions which when executed by a processor carries out the steps of: generating data according to an application layer protocol and supplying the data to a first network interface; receiving data from the first network interface; determining to effect a handover and supplying data to a second network interface; and generating a message for transmission via the first or second network interface, said message including a destination address identifying the second network interface for receiving data.

The invention is particularly applicable in a peer-to-peer communication system, where a data stream transmitted from one user device can be intended for a user device which is not directly connected to the one user device. The data stream carries address information about the intended destination device. When a communication session is established between a source device and a destination device, a channel is opened over which data is transmitted from the source device and return data is received from the destination device. In a scenario where the application determines to open a second channel, the communication session would, absent the invention, be dropped and the user of the source device would have to re-establish the connection. This can be irritating and frustrating to a user, and can lead the user to consider that there would be no point in re-establishing the dropped connection.

By generating a message for the destination device when the application opens a second channel for the communication session, which identifies a destination address for the second network interface, the destination device directs its own data stream to the new destination address and thus successfully maintains a connection with the source device for continuing communication.

It will be appreciated that while it would in theory be possible to set up a communication session over the second channel in the same manner as over the first channel, this would take time and be disruptive. This can be avoided by providing the destination address to the far side device over the first channel, so that it is ready for immediate use by the second channel.

The application can determine to affect a handover based on receipt of an indication from an access layer implemented in the source device, as described more fully in our co-pending Great Britain Patent Application No. GB1115812.8, filed Sep. 13, 2011, and U.S. application Ser. No. ______ (Attorney Docket No. 4054.1210-000), both of which are incorporated herein by reference in their entirety.

The network interfaces can be wired or wireless. Embodiments of the invention are described in the context of wireless device in a wireless communication system.

Alternatively, the application may determine to effect a handover by itself monitoring the quality of available network interfaces. The list of network interfaces can be obtained via the operating system. In such a technique, the access layer (for example the MAC layers) do not need to monitor their connection properties. Based on information which it receives about network interfaces from the operating system, the application can determine which wireless access technology to utilize, and thus which network interface to direct traffic to. This decision can take one or more factors into account: price, signal strength, packet loss, round trip time (RTT), jitter and similar. For quality parameters which cannot be measured reliably, the application may replace a currently measured parameter by a history, so that a network becomes preferable if it historically performed better than the currently used one. A history aggregation of parameters could be established in a variety of ways.

In many real life cases, a WiFi may be available, but of poor quality. For example, the signal strength may be low or a WiFi router may be overloaded. In such scenarios, data transmitted over the WiFi network is often subject to packet loss or jitter which in turn has severe detrimental effects on real time applications such as a voice or video calling.

Therefore, using a WWAN is a better option, even if WiFi is available. Also in a scenario where the user moves away from a WiFi router (for example when leaving home or office) the deterioration of the WiFi connection can be detected and a handover can be affected by the application to the WWAN network before actually losing a connection with the WiFi network resulting in uninterrupted service.

It will be appreciated that, in contrast, in a situation where an operating system priority list determines the network, there will be a change of network only after the radio chip 224 has informed the operating system that it has lost connection (i.e. that the first network is unavailable).

Furthermore, in some cases, it is advantageous to move an application's traffic from WWAN to WiFi. This is because a good WiFi network typically offers higher bandwidth than a WWAN network, with less battery usage. Also, a WWAN connection may be subject to a limited data plan or per traffic charging, making it a costly resource for the user.

### BRIEF DESCRIPTION OF THE DRAWINGS

For a better understanding of the present invention and to show how the same may be carried into effect reference will now be made by way of example to the accompanying drawings.

FIG. 1 is a schematic view of the communication system;

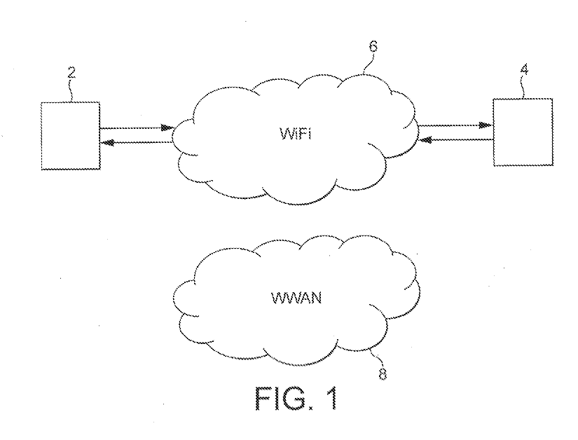

FIG. 2 is a functional block diagram of a user device;

FIG. 3 is a functional block diagram of the user device in accordance with one embodiment of the present invention;

FIG. 3A is a schematic diagram illustrating layers in an a protocol stack; and

FIG. 4 is a schematic diagram showing interaction between an application layer and an access layer.

### DETAILED DESCRIPTION

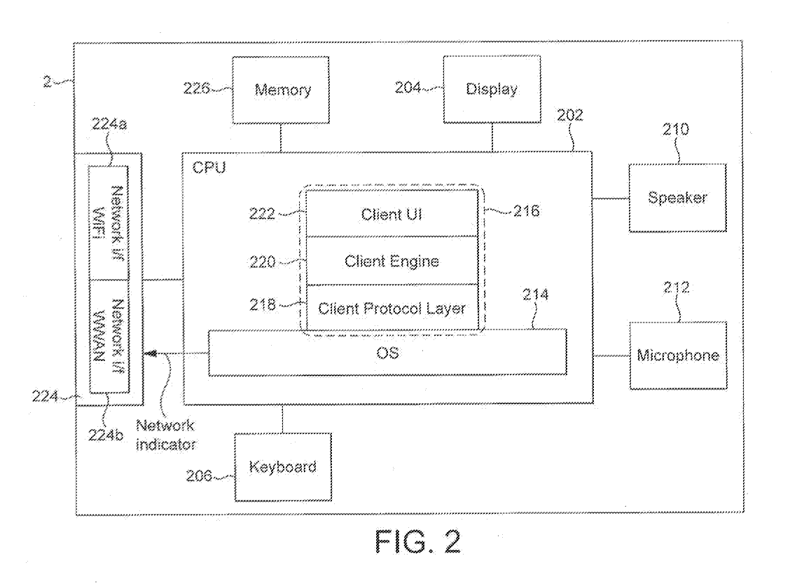

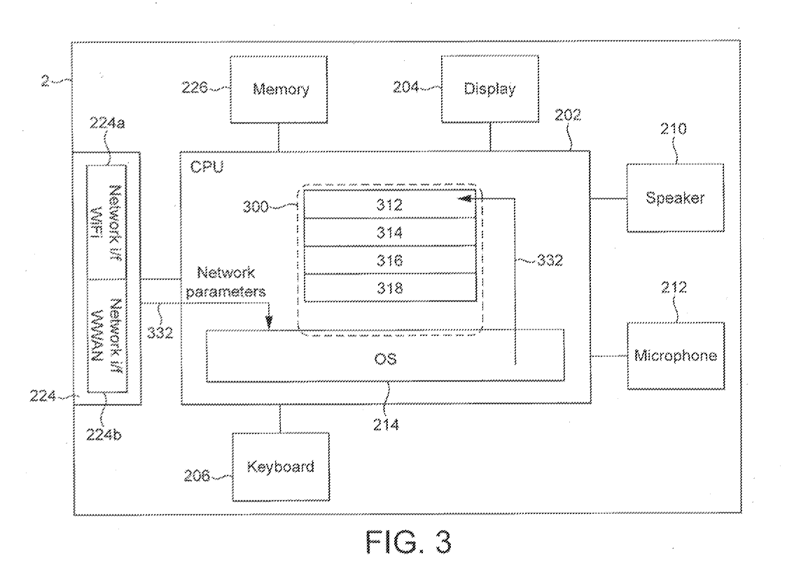

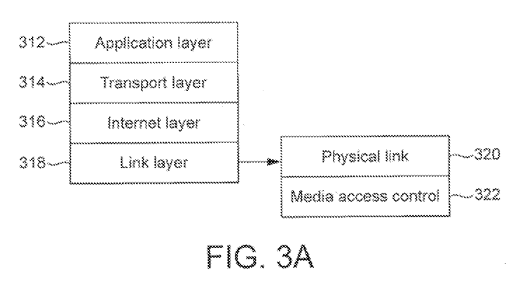

The invention will now be described in the context of a wireless device of the type discussed in relation to FIG. 2, modified as shown in FIG. 3. The wireless device can be any piece of user equipment (UE) which supports at least two radio access technologies, for example, WWAN (UMTS, HSDPA, LTE, Wimax) or WiFi. Software for execution by the processor is organized in a protocol stack 300 of the type illustrated in FIG. 3A. FIG. 3A illustrates only one example of a stack—there are many variations currently in slue and the invention can be applied in any type of stack. The stack 300 exemplified in FIG. 3 includes an application layer 312, a transport layer 314, an Internet layer 316 and a link layer 318. The link layer is subdivided into a physical link layer 320 and media access control (MAC) layer 322.

The link layer is responsible for organizing communication technologies for the device 1. The media access control layer 322 within the link layer 318 is responsible for addressing, assigning multiple channels to different users and avoiding collisions amongst other things. Each layer can communicate with its equivalent layer in a different wireless device—the link layer 318 communicates with a corresponding link layer in a different device at the level of RF data in the form of frames. Frames are transmitted and received over a channel between the radio access chip 224 (FIG. 2) and the network 6 or 8, in a communication session.

The Internet layer provides Internet communications in the form of packets carrying IP (Internet Protocol) data with IP headers, and is responsible for IP addressing. This layer applies IP headers to data packets to define a destination (far end) device—these are distinct from IP addresses applied by the application to direct a packet of a data stream to a particular network interface as discussed later.

The transport layer 314 runs host-to-host communications according to the transmission control protocol (TCP) or a user datagram protocol (UDP), for example. In this context, a host is any kind of user equipment seeking to communicate wirelessly.

The application layer 312 handles application-based interactions on a process-to-process level between communicating hosts. It is this layer that runs user applications which may generate data to be transmitted over the channel. For example, the client UI and client engine of FIG. 2 can be executed in the application layer 312. Thus, embodiments of the invention are described in the context that a user equipment runs at least one application that connects to the network 6, 8 through at least one of the radio access technologies through the media access control layer 322.

The invention can be used with a number of different applications, but one particular context concerns social communications, such as VoIP (Voice over Internet Protocol) calls between US's, instant messaging (IM) chat or live meetings run over a conference framework. Alongside these kinds of services, applications can be responsible for data transfer, such as file transfer, updating presence information for contacts in a social network, or control data such as “keep-alive” data. References to applications running in the application layer in the present cases are considered to encompass all such possibilities.

Reverting to FIG. 3, it is noted that the physical elements of the user device are similar to those of FIG. 2, and carry the same reference numbers. Of importance however the OS 214 no longer provides a network indicator to the radio chip 224. Instead, network parameters 332 are monitored by the OS 214 and are supplied to the application layer.

The application layer 312 uses the network parameters to determine whether or not to switch networks. It can also take into account information consisting of parameters such as price. The network parameters can include signal strength, packet loss, round trip time (RTT) and jitter.

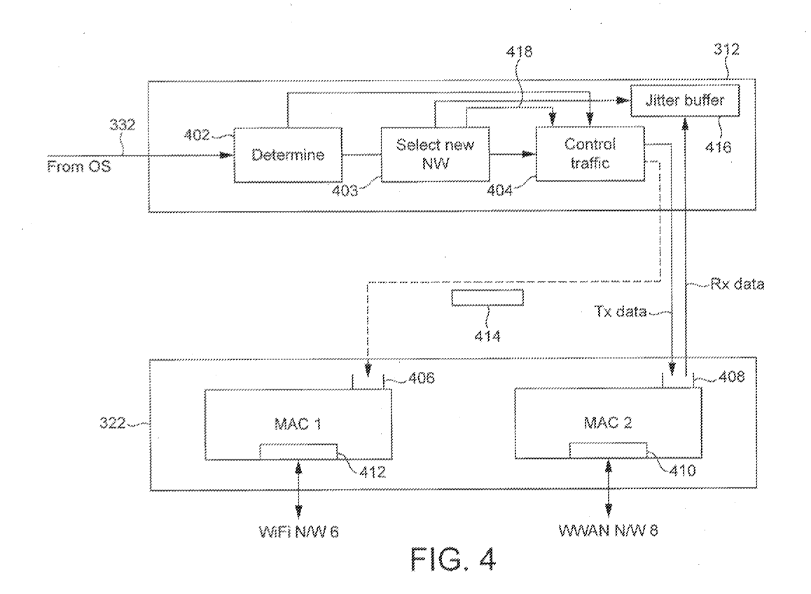

With reference to FIG. 4, the response of an application executing in the application layer 312 to receipt of the parameters 332 is explained. Before doing so, the addressing protocol will be described.

FIG. 4 shows two sockets, 406,408 at the same port. In this context, a socket is characterized by a unique combination of a port and an IP address. An application can open a socket in the operation system and bind it to a particular IP address and port.

This IP address is the IP address of a local network interface card. By binding to the IP address 0, the application does not define which network is used—this would be left to the operating system.

Conversely the application can control which network interface is used by specifying an IP address when opening a socket. So, the application sends data on a specific network interface by opening a socket with its IP address, and then transmitting data on the socket. In fact, the application has no direct access to the IP packet header so it cannot set it itself. Just as an application sends data on a socket, it can listen to it for any incoming data. The application first determines 402 how to use the parameters, for example by current or history aggregation or a combination of the two, and determine whether or not to change network from the one which is currently being used by the application for the transmission of data. If there is no change, the application continues to control traffic 404 on the existing network (shown as the WWAN network 8 via layer MAC 2). This is done according to the socket 408 opened by the application for that traffic, which is the IP address of the WWAN network 8 at the port The application continues to listen to that socket for return data.

If the application determines that it should respond to the identifier 332, it can select a new network 403, open a second channel and control some or all of its traffic to the new network (shown by the dotted line in FIG. 4), by opening a socket 406 on the new IP address and transmitting data on it.

In the following, the process of moving data to another network interface is referred to as a “handover”.

When data is moved to another network interface, unless the far-side acts as a server and reflects requests to their origin, even though an application moves its outgoing data to another network interface, any incoming data will still arrive on the old one. That is, data transmitted over a channel where the far side device would be addressing its data to socket 410, even when it should be using socket 412 after handover. Therefore, in a typical peer-to-peer system, it will be necessary to notify the far side about the new destination IP address to use. This is complicated by the fact that the new destination IP address obtained may be a private one that cannot be targeted directly by the far side device. However, well-known so-called Network Address Translation (NAT) traversal techniques exist for this problem.

Thus when applied to a peer-to-peer system, the application sends a message to the far side device identifying the new destination IP address when there has been a change in network interface. It will be appreciated that the far end device 4 is in all important respects similar to the local device 2. Therefore reference will be made to FIGS. 3 and 4 to explain operation of the far end device. When it receives a message 414 identifying a new destination IP address, this is taken into account when addressing packets of data generated by the application, in the internet protocol layer 316 in a manner per se. Thus, subsequent packets in the communication session will be directed to the correct input socket at the received side.

Moreover, the application may carry out one or more of a number of steps in order to make the transition from one network to another as smooth as possible.

Instead of instantly moving traffic to a new network interface, the application may choose to make use of both the new and the old interface for a while. Outgoing data may be sent redundantly on both interfaces, in order to ensure stable delivery during a “warm up” interval of the new channel. Also the application should continue to monitor both sockets for received data in this interval to avoid disruption in the incoming service.

When switching to a new network, the bandwidth of it is unknown. Therefore, the application can limit its data generation rate in a time interval after moving to a new network interface. The time interval and the data limit may depend on the new access technology. For example, limitation may not be needed at all when moving from 3G to WiFi, whereas, a strict limitation in the ballpark of 100 kbps may be reasonable when moving in the opposite direction. A message can be sent to the far side device to do the same. Alternatively, the far side device is set up to make the limitation when receiving the message 414 to start sending to another IP. Data rate of the local device and/or the far side device can be managed in the respective control traffic function 404. In FIG. 4, control line 418 represents an adjust data rate control from the select new network function 403. In the far side device a similar control 418 is created responsive to receipt of the message which is sent to the far side device from the local device to adjust the data rate.

The following proposals affect a jitter buffer which is in the path of a received data stream.

A jitter buffer 416 is used at the receiving terminal to order the data packets in the correct sequence and to allow for the concealment of the variations in the propagation of the data packets. The jitter buffer is placed on the receiving path of the terminal and receives incoming data packets from the network. The jitter buffer buffers the incoming packets by introducing a delay before outputting data from the packets. Typically the jitter buffer adapts the delay according to variation in the rate at which the packets are received from the network. The jitter buffer is also arranged to reorder the packets that arrive out of sequence into the correct sequence and to discard packets that arrive too late to be included in the correct sequence. Increasing the delay introduced by the jitter buffer reduces the number of packets that arrive too late to be included in the correct sequence. Increasing the delay introduced by the jitter buffer also conceals larger delays in the propagation of the data packets.

When switching to a new network, some disruption in service may be inevitable. For example, a 3G connection may have 100s of milliseconds higher end-2-end delay as compared to a WiFi connection.

In order to conceal this for the user, jitter buffer delay for data received over any of the connections may be increased for an interval from the handover. Also, a message can be sent to the far side device regarding an upcoming handover for it to do the same. That is, when an application determines to move its traffic, it can postpone the actual moving of data for a few seconds, in order to carry out the preparation steps in advance.

As an alternative to sending a message to the far side to have it increase its jitter buffer delay, the local side device can gradually introduce jitter, i.e. variations in the transmission rate of packets in its outgoing data stream; this will make an adaptive jitter buffer sitting at the far side increase its delay automatically.

It should be understood that the block and flow diagrams may include more or fewer elements, be arranged differently, or be represented differently. It should be understood that implementation may dictate the block and flow diagrams and the number of block and flow diagrams illustrating the execution of embodiments of the invention. It should be understood that elements of the block and flow diagrams described above may be implemented in software, hardware, or firmware. In addition, the elements of the block and flow diagrams described above may be combined or divided in any manner in software, hardware, or firmware. If implemented in software, the software may be written in any language that can support the embodiments disclosed herein. The software may be stored on any form of non-transitory computer readable medium, such as random access memory (RAM), read only memory (ROM), compact disk read only memory (CD-ROM), flash memory, hard drive, and so forth. In operation, a general purpose or application specific processor loads and executes the software in a manner well understood in the art.

While this invention has been particularly shown and described with references to example embodiments thereof, it will be understood by those skilled in the art that various changes in form and details may be made therein without departing from the scope of the invention encompassed by the appended claims.

What is claimed is:

1. A method of transmitting data from a source device to a destination device in a communications system, the method comprising:
at the device, executing an application which generates data according to an application layer protocol and supplies the data to a first network interface for transmission in a communications session over a first channel;
the device receiving data at the first network interface for supply to the application;
the application determining to effect a handover and opening a second channel for the communication session;
the application supplying data to a second network interface for transmission over the second channel and generating a message for transmission over the first or second channel to the destination device, said message including a destination address identifying the second network interface for receiving data over the second channel.

2. A method according to claim 1, wherein the message is transmitted over the first channel.

3. A method according to claim 1, wherein the application determines to effect a handover based on network parameters supplied to the application.

4. A method according to claim 3, wherein the application determines to effect handover additionally based on information supplied to the application separately from monitored network parameters.

5. A method according to claim 1, wherein the application effects a handover by opening a socket to which an address of the second interface is allocated, a data stream being directed to the socket.

6. A method according to claim 1, wherein after determining to open the second channel, the application introduces variation in the transmission rate of data.

7. A method according to claim 1, wherein after opening the second channel, the application supplies the data for transmission over both the first and second channels for an interval after said opening.

8. A method according to claim 1, wherein after determining to open the second channel, the application reduces the rate at which data is supplied to the access layer for transmission for an interval after said opening.

9. A method according to claim 1, wherein after determining to open the second channel, the application transmits to destination device which was in communication with the device over the first channel an instruction to reduce the rate of data transmission from the destination device to the source device.

10. A method according to claim 1, wherein after determining to open the second channel, the application increases the delay in a jitter buffer at the source device.

11. A method according to claim 1, wherein after determining to open the second channel, the application transmits a message to the destination device which was in communication with the source device over the first channel to instruct the destination device to increase the delay of a jitter buffer at the destination device.

12. A method according to claim 1, where at least one of the first and second network interfaces is wireless.

13. A device for receiving and transmitting data in a wireless communication system, the device comprising:
a processor arranged to execute an application which generates data and supplies the data to a network interface for transmission in a communication session over a first channel;
the network interface receiving data from a source device over the first channel;
the application arranged to detect in a stream of data received over the first channel a message including a destination address identifying a second channel for the communication session, and supplying data for transmission in the communication session over the second channel.

14. A device according to claim 13, wherein the message identifies a destination address of an alternate network interface of a source device to which data transmitted from the wireless device is to be directed.

15. A device according to claim 13, wherein the application is arranged to detect a message indicating a reduction in data rate for an interval after opening of the second channel, wherein the device comprises a data rate controller for reducing the data rate.

16. A device according to claim 13, wherein the application is arranged to detect in the data stream a message indicating an increase in jitter buffer delay, the device comprising a jitter buffer and being operable to increase the delay in the jitter buffer responsive to said message.

17. A computer program product comprising a non-transitory computer readable medium storing thereon computer readable instructions which when executed by a processor carries out the steps of:
generating data according to an application layer protocol and supplying the data to a first network interface;
receiving data from the first network interface;
determining to effect a handover and supplying data to a second network interface; and
generating a message for transmission via the first or second network interface, said message including a destination address identifying the second network interface for receiving data.
